(19) United States
(12) Patent Application Publication
(10) Pub. No.: US 2003/0195933 A1
(43) Pub. Date: Oct. 16, 2003

(54) Web filter screen

(76) Inventors: Thomas Charles Curren, Arcadia, CA (US); Robert Jose Hernandez, Pasadena, CA (US)

Correspondence Address: ROBERT JOSE HERNANDEZ, SWT 205, 622 E. VILLA ST., PASADENA, CA, 91101, US

(21) Appl. No.: 10/120,129

(22) Filed: Apr. 10, 2002

(51) Int. Cl. G06F 15/16

(52) U.S. Cl. 709/206; 709/246

(57) ABSTRACT

A system is shown where a web message is sorted by a hierarchical sort that examines a series of different aspects of the message and stores the web message in appropriate memories sealed from the main memory of the computer thus allowing either block or individual examination and elimination of unwanted spam. A further refinement shows a system and method to assist the user without access to drop down menu formats and that further provides directional information on the prior steps taken before help was requested and the steps available from that point forward.

### PRIOR ART AND BACKGROUND

There is a major problem in hacking, the unauthorized entry to a computer system, and in contamination of computer systems. Companies and individuals with frequent direct connections through the web to their computers are constantly at risk of an attachment or a hacker attack, either of which may result in the loss of important personal, financial or confidential information. Moles, a newer spam variety result in the user PC sending information back to the spammer telling about the user or the user system. They can reek havoc upon PC systems. In general, invasion problems are a continuing and difficult problem with web commerce and web connectivity.

There have been a variety of solutions to the invasion problems. All of the present methods are based upon negative rejection principles or operating methods. One, and the most common at present is to connect the computer only when needed and to carefully control access by others. In many cases an isolated computer separated from main systems is used to shelter the main system from interference and problems. Unfortunately, this answer defeats the ease of E-Mail communication and slows access to information. With immediate information access expected and many web information exchanges in real time, rather than as pass along information, the isolation and filtering of data is not successful in most applications. Images are especially vulnerable since they have code that in essence says “go get this picture from the hackers (spammers) computer”. This off site referencing can also be used to activate a virus program. There is a real danger that an accepted code (HTML or image code) will have an undetectable attachment or addition that is harmful. Since most E-Mail is sent using HTML code, merely viewing an E-Mail can activate a program that contains a virus or that disrupts a user PC.

Another approach is to set up a wall, generally called a firewall that separates a part of a computer drive or has a dedicated computer drive responding to the outside web connections but providing a high degree of isolation of the signals from contact with the remainder of the computer system or network. This type of isolation is however not perfect and it attracts the attention of hacking with the goal of breaking the isolation barrier. Such an isolation system further will not always prevent an attachment from an otherwise acceptable message or information set from being forwarded through the firewall to the main computer system or network. This type of system has serious problems in speed of access and in failure to provide a cure to the problems of hacking and contamination.

Yet another system is to set up a temporary isolation of incoming information and then compare the information against a comprehensive list of known contaminating code sets with rejection of any messages or information sets that contain these known contaminating code sets. This negative rejection system requires a list of items which are not allowed. Much like the American Criminal Codes everything is allowed if it is not specifically disallowed. This system is very effective with contamination if it has the following properties:

a) the contaminant is known

b) the list of known contaminants has been updated

c) the update is in time to catch new contaminants

No unlisted contaminant (one known as rejectable) will be caught with this system and as the list of possible contaminants grows exponentially over time, the list comparison becomes unwieldy and time consuming. Such a system also deals with past problems, preventing a recurrence but does not contain new problems. This solution is thus not a complete answer and it does not address the problem of hacking.

Yet another system that can increase safety of computer-web connections is to define likely attachment sites and contents of contaminants and to screen and isolate these specific sites for extra content and for the specific code identified as likely content. Such a system is not tied to frequent update of lists and is forward looking in its identification but the contaminant must be conform to the sites and contents constraints searched for it to be identified.

In available programs such as Outlook Express, ActiveX, JavaScript or Java applets are run without notice or any warning. These small but very powerful programs can provide hackers an opportunity to change the user hard drive or alter the user computer. There is no easy way to screen out these additions.

The multitude of systems noted above range from limited use to sophisticated guesses as to sites and content of contaminants. They all have serious problems as well as providing at least some protection against contamination.

The hacking problem, the unauthorized entry into computers, is also treated by a variety of solutions. Clearly is connections are only done for limited times and under direct supervision, the opportunity for hacking is also reduced. In addition a series of increasingly sophisticated systems of passwords and shutdown criteria limits the access to computer systems. The passwords, often used in layers, are penetrable by systems to crack passwords that rapidly run programmed word combinations up against the keyword barrier. With frequent use of simple or obvious words, passwords are often broken. A response to this breaking of passwords is to allow a limited number of or time of password responses before disconnection. As hacker avoidance continues as a problem, increasingly complex protection systems are being attacked by increasingly competent hacking. There is no present simple protection method against hacking.

The problem of E-Mail and similar electronic communication in addition to contaminants and hacking is spam, unsolicited (and sometimes harmful input that may be attached to a seemingly legitimate communication). The volume of spam is a major problem with a number of commercial firms providing net ad services that can easily overwhelm a user with pure volume.

To date two major approaches have been used to prevent improper inputs from the web or other sources to the computer. In one type, tails, strings of program information attached to text is the subject of search procedures and when a tail is found alarms, segregation or automatic deletion is provided by the search program. In another type word search is used to inform and protect by deletion all text that contains any of a series of selected words that indicate that the incoming text is advertisement, prurient, or otherwise unwanted.

In the first type search, a key factor is registering tail combinations that have been detected and may be harmful. This requires frequent updating of the program reference files. It also requires continuously growing amounts of memory for reference files, and as memory increases, speed of the program can be adversely affected.

In the second type of search the innocent use of selected words such as “sale” in an otherwise desired text transmission may result in improper identification as an incoming spam and the subsequent deletion of the text. Since the searched words also become known, there also are a number of artful transmissions that avoid the key reject criteria words and this spam is allowed past the search barrier, wasting time of the user. Again, the use of specific terms to reject just offers opportunities to find end runs around these terms.

Yet another type of contaminant is recently looming, a virus or other unwanted addition located within the address slot of an incoming E-Mail. The address area may have up to 100 characters of space for identification of other uses. This space would be normally imported with the address information into the receiving computer. Some contaminants are now being hidden at the end of this long space and is usually ignored if the start of the space is partly filled or not used at all. Ignoring the entirety of this space is a risk and commands may exist in the last few spaces of this area. No present program looks at this space or screens addresses sufficiently to remove this potential area of contamination of a computer system.

There is a need for a better and more accurate search method for protection of computer systems and networks from spam. At present, there is no simple but effective method to eliminate most spam that also prevents the end runs by use of new or different terms.

### DESCRIPTION OF THE INVENTION

This invention provides a screen against spam that is simple and effective based upon positive acceptance rather than negative rejection.

This invention provides a simple method to pre-screen information and to prevent contact with some hacking and contaminants.

The invention provides a further protection in that it does not interfere with other protections but does limit use of these resources to messages that are pre-approved or pre-screened i.e. those messages that are positively accepted by the early screening features of this invention

The invention further provide for absolute rejection of many junk mail type of messages thus limiting the need for much protection against contaminants and rejects known sources of bad data. In addition the invention provides for a novel system to help it be used. This hypertext help function allows ease of calling up directional instructions without calling up menus and allows prior and future steps to be clearly shown by arrows or similar indicators.

The system herein, a multi-selection system for information filtering, provides prescreening of E-Mail and web contacts. Since this prescreening is based upon lists of pre-accepted terms or addresses or other features, it is the opposite of existing systems which allows safety in making an end run around the screening method more difficult and since it is opposite of existing methods allows those methods to also work with all or part of the incoming material to provide further safety and selectivity.

The invention rejects the present sorting methods and provides a multi-step hierarchy of positive acceptance that can be used with present programs, or as a stand alone sorting system for spam. Inter-method compatibility is unique in this method since the method shown herein and existing systems working on different principles are not mere overlays of similar systems but are two distinct and different approaches that are compatible.

The invention searches and accepts from select source addresses, files for further screening or for review other addresses and rejects all input from selected or non-identified sources. This listing of acceptable items is positive and does not rely upon input of all recent problem codes and addresses but relies only on user positive input. It is more effective to allow specific terms or items rather than searching for and rejecting all the terms in the world that have had a problem.

This method uses input of both keyword and source address as sort criteria. There is a first list of authorized sender addresses which places the E-Mail in a priority location and so notes upon a screen. From the priority location, the E-Mail may be accepted, previewed before placing in a general computer location, or forwarded directly to a selected memory location. This is a positive forwarding based on the allowable, not on the rejectables. A second screen allows certain keywords to act as a replacement criteria for the acceptable sender addresses with the same range of accept, safe screen, forward or store options for handling the message.

Lacking acceptable keyword or sender address information the bulk of messages are entered and stored in a unknown E-Mail location behind firewall protection where these messages may be safe previewed, accepted, rejected or forwarded or stored at the option of the user.

Two sets of files are automatically removed from the unknown E-Mail file by use of the hierarchical sort process. The junk mail testing consists of examination of the headers for a specific acceptable recipient and an acceptable header content. Acceptable header content is defined herein as one that conforms to the E-Mail standard. If the junk mail does not get removed by the two tests, then it is automatically relegated to the junk mail category. In addition, junk E-Mail that is determined by word content of user selected words in the headers and banned E-Mail, where selected user added sender addresses are segregated and then placed into separate files where they can be screened and then rejected or forwarded. A person involved with boating as an example might list the work “kayak” and whenever a text had the word kayak in title it would be segregated as acceptable E-Mail.

Acceptance of specific title words contrasts with most present sort systems that examine text for the sort criteria. In text search systems, to examine the text the file has to be opened at least in part which, since contaminants can be within the text, requires neutralization of the partly open text. The neutralization is difficult and offers further complexity to a protection program that the present invention, by sorting title elements, does not require. The mailbox filter system thus can have increased effect with a simpler sort process. The mailbox thus does not go into content scan processes since they are often flawed and scan content deletions may cause distortion of the contents scanned by deletion of key words or elements.

An attachment arrives with a file name. The screening process which neutralizes attachments in part dynamically (as part of the process) adds a secondary extension to existing extensions. This is drastically different from existing processes for screening which remove the extension and provides the ability to set the attachment aside and screen it and then be able to see if, by removing the added second extension, restore the identity of the file. The ability to not obscure the original file extension makes it easy to subsequently receive the file since the type is known.

The secondary extension added as part of the neutralizing sequence is made configurable by addition of either a default extension such as .TXT or any other customizable extension. The obvious advantage of a customizable extension is that it would be readily identifiable as a file that was neutralized by the screening process.

The screen process allows the user to maintain a safe list of non-neutralized extensions which are allowable and thus permit a frequent user of the E-mail system to bypass the neutralization process with the “free pass” from the safe list. The extension .JPEG for example could be allowed as a safe extension, and thus passed through the neutralization, or it could be enhanced with another (secondary) extension to make the non-safe list extension more identifiable.

The safe list thus provides a trusted source bypass of the screening system. If an extension is on the safe list it rapidly bypasses the screening system. The safe list also, in cases where the incoming E-mail is not on the safe list, allows ease of identification of the E-mail as not usual incoming file types.

The hierarchical system of positive acceptance based upon user addresses as well as on content provides safety and barriers to acceptance of false and dangerous E-Mail. The multilevel system also provided for a series of quick sort of acceptable E-Mails (from listed addresses) and all others and further deletes from the all other category selected word and address areas thus reducing the volume of unknowns that need screening.

The net effect of this method is a provision of added security and pre-sorting that is not possible with word sort of tail sort techniques or negative rejection criteria alone. A multi-step system by providing priority input from only a small number of acceptable addresses acts to bar most inputs and select desired E-Mail.

The small number of resulting priority E-Mails allowed with this system and the compatibility of these sort and classification criteria with other sort methods sets this method apart as does the use of sender addresses as a key sort criteria.

### DESCRIPTION OF DRAWINGS

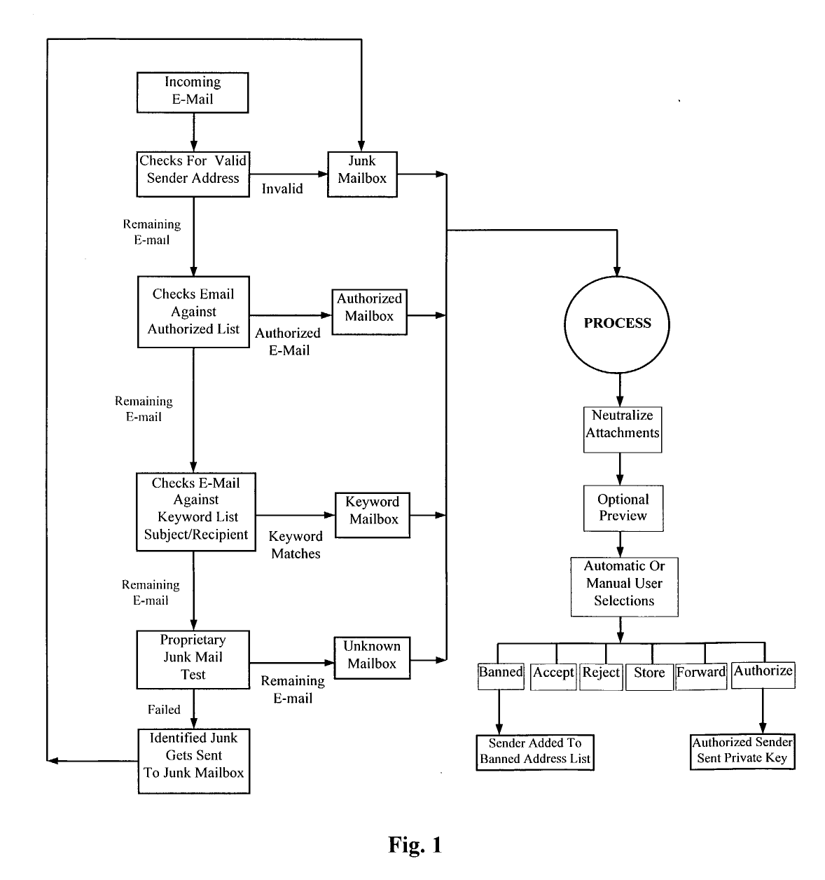

In FIG. 1, a block diagram shows the successive screen methods and illustrates the hierarchy of rejection and acceptance modes.

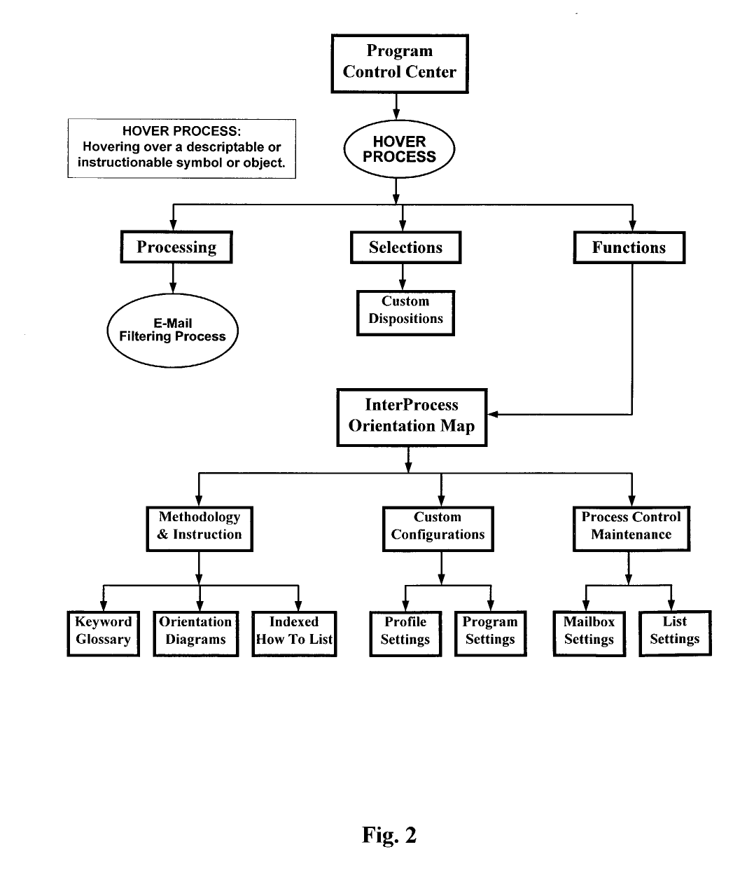

In FIG. 2, an example of the specific sequence of key number/source tags is shown diagramed.

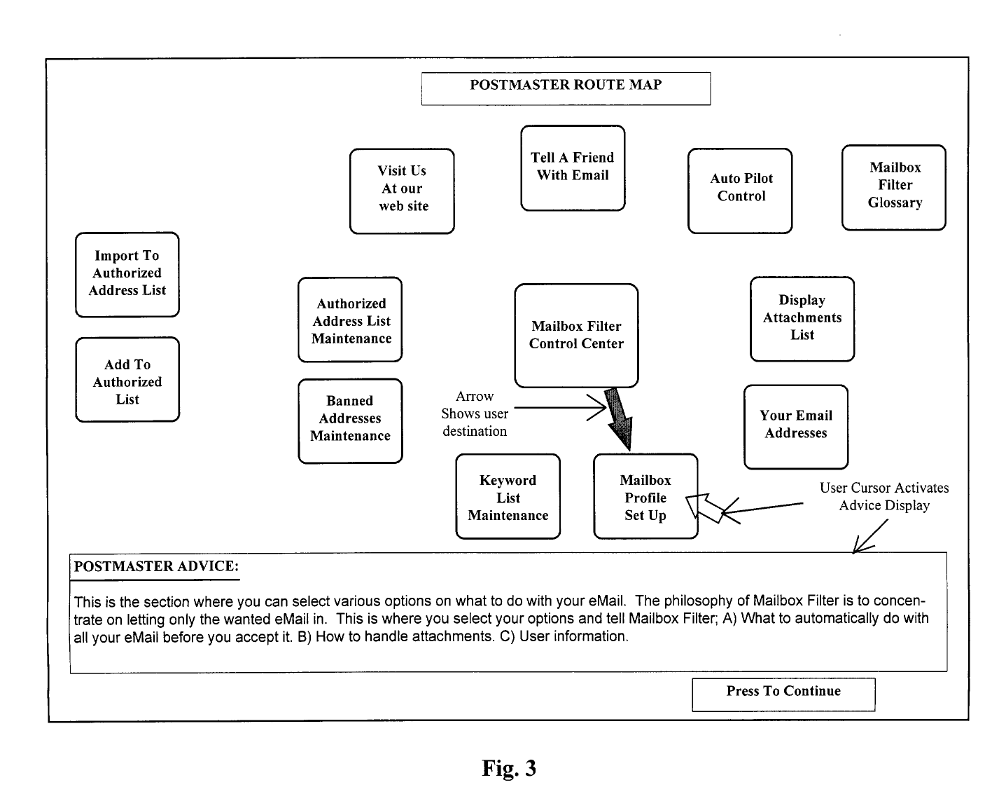

In FIG. 3, a help system attached to the basic screening system is shown with the real time assistance allowed by clicking onto each screening function.

### PREFERRED EMBODIMENT OF INVENTION

In the preferred embodiment of this invention, a screening system is established that receives an incoming E-Mail and performs the following functions upon the message.

The screening system first examines the address tag of the sent E-Mail. The address tag is compared to a list that is loaded into the program file containing addresses that are accepted without further screening of source. A positive screen is performed—i.e. if the address tag is listed as acceptable, it is processed as accepted. When accepted the E-Mail file is placed in a first register for further processing.

If the E-Mail address tag is not on the accept list, there is a further processing step consisting of a further screen against a pre-loaded list of non-accept addresses. The E-Mail from these non-accept address tag locations “discarded” immediately. When we discuss discarding in this context, it is a non-accept that prevents the E-Mail acceptance but it is placed into a junk mailbox where it may be screened or disposed of as junk, store (doubtful) or forward as the user determines then after all dispositions are complete the user may delete files of the unaccepted E-Mail at his option. Normally all E-Mails with no address tag would also be placed into this reject category since it is common for spam to be without an address. The user may, however, allow nonotag mail to be placed in the register noted below as residual.

With the first two screens, there is a residual of messages that are neither accepted without reservation or totally rejected. These residual messages are placed into a second register where they may be individually scanned by the user or may be further sorted.

One further sort mode is provided that allows a positive word search sort with a user pre-loaded list of key words or phrases used to further sort and accept or totally reject E-Mail messages. If the incoming residual message contains any listed word or phrase, it is removed from the register and placed into a special register for further examination, or if a unwanted term is found listed upon an unwanted list, the message is placed in the reject category, thus totally deleted.

A further novel feature of the present invention is the provision of a help feature that is based upon hypertexting help information on each function of the sort procedure such that it may be accessed not with the separate help function. This system, called herein the hover function, allows the use of a pointer or mouse over the icon or function box and unlike most systems provides automatic engagement of the hidden instruction sets without the click, right click or double click of the mouse at that function. The readily available help feature further makes the sort features user friendly and provides detailed instruction on demand.

The E-Mail filtering system receives an E-Mail from normal connections between a computer and a web server. This Incoming E-Mail is first checked for a valid sender address.

The validity of a sender address is determined by the tags and consistency of the address format. The scan of the incoming E-Mail is performed as the first step in the overall selection process. Any E-Mail that does not have a valid sender address is relegated to the junk mailbox where it is held in limbo until further sort, confirmation and neutralization processes are performed.

Valid E-Mail addressed mail, the remainder of the incoming material, is then forwarded for a second scan, this time for checks against a list of pre-selected authorized addresses. If the incoming E-Mail is on the authorized list, this positive acceptance criteria allows it to be then immediately forwarded to an authorized mailbox location where it is stored for further processing.

The remaining incoming E-Mail is the matter that has a valid sender address (but not necessarily a desired sender address) and is not on the list of pre-authorized E-Mails. This active remainder is then sorted by keywords which include subject and recipient lists the user of the system has entered as areas of interest and as individuals who are cleared. Note that the list is basically a positive acceptance list, presence of a keyword accepts not deletes due to the presence of the keywords. This scan is important in that it is the first step entering the text of the message where the presence of the selected keywords and names within the message is a criteria for initial acceptance. This third sort scan provides acceptance if a name of an approved person is used within the message or if the subject matter is an area of listed interest to the user of the sorting system. E-Mails that meet this step sort process are stored in a Keyword mailbox for further processing as accepted E-Mails. The remaining E-Mails not accepted then enter the fourth step scan.

The Internet format in HTML images are sent, not as a very large file but as an offsite reference to a open communication port which is accessed by the receiving computer. If a received message is in Java or Visual Basic an image or a reference can be embedded in script. The mailbox filter can analyze and the HTML input can be first neutralized, then the off-site references can be wiped out, passing along only text portions of a message. The process of first analyzing for HTML, then neutralizing the HTML followed by removal of off-site references provides protection against contamination, unknown attachments and virus code located both off-site and, other than by noting a offsite reference, undetectable.

In scan four, there is a final test for proprietary junk mail where the mail that has a previously identified junk mail designation is again screened and E-Mail that has not been sorted out as junk in step 1 or as acceptable in steps 2 and 3 is tested against a limited user loaded list of known junk mail providers who have a valid address (it passed screen step 1) and yet have no authorization or content that would place the mail in acceptable categories of scans steps 2 and 3. The user (qualifier) list would typically be small and allows the user to unsubscribe to specific addresses of messages. This qualifier list is non-comprehensive but it helps qualify what to accept—it looks at whether or not an item is qualified and then if listed as unwanted disqualifies that item or message and sends it for further processing then after a disposition is made, the item or message may be deleted at user option. If the E-Mail to this point has a known junk mail address, it then is sent to the junk mailbox as were rejects from scan 1 for further processing. The E-Mail not from known junk mail addresses (which would have been removed by use of a user reject list) is sorted to a unknown mailbox storage sire for further disposition or processing. The user reject list can be taught further addresses to improve effect of the sort system. If the mail has no reason to reject, it then goes to unknown.

After the 4 scan steps, the incoming E-Mail has been relegated into the junk mailbox, an authorized mailbox, a keyword mailbox or an unknown mailbox. These separate storage sites contain mail of sorted different levels of interest. They are not innocuous in that they may have virus attachments and may still be of little real interest to the user.

Another feature of the system is a use of text only entry into the system. In a HTML format of images sent in most uses the access to the images is not a true downloading but instead opens a communication port between a computer/server with the stored images and your computer. If Java, Visual Basic, or some other imaging systems are used, there can be embedded script messages within the image files that can contain destructive programs (virus).

With this system, an off site reference to HTML images can be neutralized. This neutralization wipes out off site references in the images and passes only the text message portion. While this neutralization process reduces the impact of many messages by reduction to only text, it allows much greater system safety by preventing opening the user's system to off site computers.

There is also another important source of secondary contamination that can enter with attachments. The address space is a good size block set for addresses. A trick that can allow entry into the user system of spurious commands such as EXE commands is to add spaces over all but the last few spaces of the long address block so that an address consists of:

an address

a designator such as .doc

a block of up to hundreds of spaces

a unwanted command.

In such a block of spaces, the command part is hidden unless for each incoming message all blocks are examined over all available spaces, not just the immediately visible spaces. This program neutralizes such added commands by crushing spaces to make the hidden line ends visible. The elimination of white space provides a check on the extra hidden parts of an address. Knowing the command is there, it is then easy to convert the attached material to benign text.

This neutralization system to prevent open communication with image holding off site computers and the elimination of white space provide greatly enhanced security against a very troublesome type of possible system It cuts points of entry available to a virus or contaminant and check that the entire address or attachment space is safe.

The sum of all files not purposely deleted after the initial 4 step scan and sort procedure are processed to ensure safety when or if the mail files are opened. The processing is a series of sequential steps which successively neutralize attachments to the E-Mail files, then allow optional previewing of the files followed by either an automatic or a manual user selection of the files into one of the following categories: banned which provides automatic entry of the sender information to the banned address list; accept which provides entry into the non-walled portion of the computer for perusal of the mail files, reject which automatically deletes the entire mail entry. Other allowed actions are store to allow entry to a storage area or file, forward and authorize which automatically adds the sender information to the authorized list and sends the user a private key to aid in communication.

While the steps of the sorting and the subsequent safety processing are critical to the operation of the protection program, the ease of use of the system is also important. The best of operating systems or procedures are useless if the user cannot easily understand each step and use the system. The use of graphical displays to profile the successive steps of the scan and sort processing is enhanced with training assistance that provides for pop-up instructions at each step covering the use and effect of each sort step—but without the need to click on the function (the hover process). The embedded text located at each portion of the display is further enhanced by a series of tell-tale indicators that further indicate the prior step that resulted in reaching the query step and suggested next steps to accomplish the sort process or to accomplish set goals as part of the sort.

I claim:

1. A positive acceptance system consisting of a set of at least a general memory register and a first secondary memory register and a second secondary memory register plus at least a first address tag register and a second address tag register, where a incoming message is received and placed into said general memory register, then the portion of said incoming message that contains an address tag is identified by address tag identification means and said identified address tag is compared with acceptable address tags loaded into said first address tag register and allowed entry into said first secondary memory register if a match between said incoming address tag and said first address tag registers is found, and if no match is found or no tag is found, the incoming identified address tag is then compared to the contents of said second address tag register and if a match or if no said identified address tag is found, the incoming message is deleted from the general memory register, then if no comparison with said first address register and with said second address register is not made and if said incoming address tag exists, said incoming message is placed in said secondary message register.

2. The claim in claim 1 where a barrier is established isolating said general memory form other functions of said computer by firewall means.

3. The claim in claim 1 where said entry into said first or second secondary memory if further screened by comparison of contents of said incoming message with a preloaded list of words and phrases and said incoming message is discarded when said words or phrases are found in said incoming message and allowed entry into said second secondary register if no such words or phrases are found.

4. The claim in 1 where a further screen is performed by examination of the contents of said address tag with a preloaded list of words or tags and said incoming message is discarded with said words or tags are found in said incoming message and allowed into said general memory if no such words or tags are found.

5. The claim in 1 where a help function is provided by embedding into each location of functions upon the screen by embedding means a text explanation accessible by means of a mouse or other pointing means.

6. The claim in 1 where a directional indicator is provided by embedding into each location of functions upon the screen by embedding means a directional indicator such as an arrow or line showing the last step taken in the sort process.

7. The claim in 1 where a directional indicator is provided by embedding into each location of functions upon the screen by embedding means a directional indicator such as an arrow or line showing the next step taken in the sort process.

8. The claim in 3 where a help function is provided by embedding into each location of functions upon the screen by embedding means a text explanation accessible by means of a mouse or other pointing means.

9. The system in claim 1 where a text explanation of each step is available by means of a mouse function.

10. A method of positively sorting incoming electronic communications where a first comparison of the message against a list of tags on the incoming message is performed and if a tag listed as acceptable is found then the message is sent to a secondary memory where it is then scanned against a list of acceptable words and if one of the acceptable words is found the message is forwarded to a general memory register and where if the comparison shows no acceptable word the incoming message is sent to a third memory register.

11. The method in claim 10 where an incoming message is deleted if said incoming message is compared to a list of unacceptable tags and said unacceptable tag is found.

12. The method in claim 10 where unacceptable tags instead of acceptable tags are listed and if a listed unacceptable tag is found said incoming message is deleted.

13. The method in claim 10 where unacceptable words are listed and if an unacceptable word is found in text of said incoming message, then said incoming message is placed in a separate reject register for further processing.

14. The method in claim 10 where an added help function is available where a help function is provided by embedding into each location of functions upon the screen by embedding means a text explanation is automatically accessible by means of a mouse or other pointing means.

15. A method of providing assistance to a sequential sorting or other computer based program of multiple steps where a help function is provided by embedding into each location of functions upon the screen by embedding means a text explanation accessible by means of a mouse or other pointing means.

16. A process where incoming message is analyzed for HTML content, is then segregated if a message contains HTML content, the HTML content is further analyzed to determine if the off-site references are contained within this portion of said content, and then off-site references are removed, leaving only text message as actually received.

17. The process in 16 where said off-site references and messages containing off-site references are segregated and said removal is initiated by a computer user.

18. A method of protecting input from off-site E-Mail where, any attachment received by a protected computer has all spaces after the attachment extension crushed or eliminated, the elimination of this blank space making visible to a user any commands or file extensions located in the normally not viewed portion of an attachment.

19. The method in 18 where said attachment is further converted to text, thus removing an entry point for virus.

20. The method in 18 where said attachments are in a segregated area within computer memory and where user must physically open attachment files because automatic opening has been prevented by said segregated area within computer memory.
